(19) United States
(12) Patent Application Publication
(10) Pub. No.: US 2025/0042762 A1
(43) Pub. Date: Feb. 6, 2025

(54) CATHODE COMPOSITION

(71) Applicant: Dyson Technology Limited, Malmesbury, Wiltshire (GB)

(72) Inventors: Juliette Marie BILLAUD ep. BOUVILLE, Oxford (GB); Matthew Robert ROBERTS, Oxford (GB); Niccolo GUERRINI, Oxford (GB)

(21) Appl. No.: 18/718,081

(22) PCT Filed: Dec. 13, 2023
(86) PCT No.: PCT/GB2022/053193

§ 371 Date: Jun. 10, 2024

(30) Foreign Application Priority Data
Dec. 20, 2021 (GB) 2118535.0

(51) Int. Cl. C01G 45/12

(52) U.S. Cl. CPC C01G 45/1228; C01P 2002/72; C01P 2006/40

(57) ABSTRACT

A cathode composition for a battery of the general formula: Li1+aMn1−bAl1−cO2; wherein the values of a, b and c are greater than 0. There is also provided a method of making the cathode composition for a battery, a cathode comprising the cathode composition, and an electrochemical cell comprising the cathode.

### TECHNICAL FIELD

The present invention relates to a cathode composition. More specifically, the present invention relates to a cathode composition for a battery. The present invention further relates to a method of making the cathode composition for a battery. The present invention further relates to a cathode comprising the cathode composition and an electrochemical cell comprising the cathode.

### BACKGROUND

Lithium-rich cathode compositions for batteries are widely known. Typically, lithium-rich cathodes require a layered structure, which can lead to problems with defects, trapped lithium ions and collapse of the layers during cycling of the battery. In addition, lithium-rich cathode compositions are usually prepared via high temperature synthesis, which is energy-intensive, expensive and can result in difficulties in controlling the reactions that take place to form the composition. More recently, lithium-rich disordered rock salt (DRS) structures have been investigated as cathode materials. However, it is currently a challenge to improve the cycling stability and energy density in lithium-rich DRS structures with known compositions and methods.

The present invention has been devised to mitigate or overcome at least some of the above-mentioned problems.

### SUMMARY OF THE INVENTION

In accordance with a first aspect of the present invention, there is provided a cathode composition for a battery of the general formula: Li₁₊ₐMn_{1-b}Al_{1-c}O₂; wherein the values of a, b and c are greater than 0.

The present invention thereby provides stable and electrochemically-active cathode compositions for batteries. In these compositions, the cathode is based on lithium, manganese and aluminium in the DRS structure, whereby aluminium acts as a stabilising structural agent. The present inventors have shown for the first time that such compositions increase cycling stability and battery performance, and not only can the above cathode compositions be produced, but also that they can be produced in a straightforward manner and cycled.

The compositions themselves are cheaper to produce and more practical than any previously reported cathode composition. In addition, the present inventors have demonstrated electrochemical activity in these compositions for the first time.

Advantageously, aluminium acts as a stabilising structural agent in the DRS structure, which enables the stability and energy density of the cathode to be significantly improved in comparison to known lithium-based cathode compositions.

The composition may be in the form of a single phase having a rock salt crystal structure such that an x-ray diffraction pattern of the composition using a Cu Ka radiation source has an absence of peaks below a 2θ value of 35.

Conventional ordered or layered lithium and manganese-rich compositions (Lₕ₊ₓTmᵢ₋ₓCₖ where Tm is predominately Mn) have lithium ions sitting in both the alkali and transition metal sites. In addition to the above, x-ray diffraction patterns of these conventional compositions will have a peak at a 2θ value of 18. However, in the present invention the x-ray diffraction pattern of the cathode composition has an absence of a peak at a 2θ value of 18. In other words, the single phase crystal structure of the present invention is absent of any spinel or layered structures, and is considered purely as a single phase rock salt crystal structure. The single phase crystal structure does not exhibit either a R3(bar)m and/or a C2/m space group.

In particular, the compositions are provided as a single phase rock salt crystal structure (i.e. face centred cubic lattice with the Fm3(bar)m space group), which may be a disordered rock salt crystal structure.

The manganese component of the composition may comprise a plurality of different oxidation states.

The manganese component of the composition may comprise Mn(III) and Mn(IV), and the composition may have the general formula:

Li₁₊ₐMn(III)_{1-b1}Mn(IV)_{1-b2}Al_{1-c}O₂

Where 1−b=(1−b1)+(1−b2).

The cathode composition may have the formula:

$${Li}_{\frac{4}{3} - \frac{x}{3} - \frac{q}{3}} {Mn ( III )}_{x - y} {Mn ( IV )}_{\frac{2}{3} - \frac{2 x}{3} - \frac{2 q}{3}} {Al ( III )}_{y + q} {O}_{2}$$

In some cases, q may be 0 such that the cathode composition has the formula:

$${Li}_{\frac{4}{3} - \frac{x}{3}} {Mn ( III )}_{x - y} {Mn ( IV )}_{\frac{2}{3} - \frac{2 x}{3}} {Al ( III )}_{y} {O}_{2}$$

The value of x may be greater than approximately 0.05 and less than approximately 0.95.

The value of x may be greater than approximately 0.1 and less than approximately 0.8. The value of x may be greater than approximately 0.45 and less than approximately 0.75.

The value of y+q may be less than approximately 0.3. The value of y+q may be less than approximately 0.2.

The value of y+q may be greater than approximately 0.025 and less than approximately 0.05.

The composition may be Li_{1.1}Mn(II)_{0.675}Mn(IV)_{0.2}Al(III)_{0.025}.

The composition may be Li_{1.1}Mn(II)_{0.65}Mn(IV)_{0.2}Al(II)_{0.05}O₂.

The composition may be Li_{1.17}Mn(III)_{0.475}Mn(IV)_{0.33}Al(III)_{0.025}O₂.

The composition may be Li_{1.17}Mn(II)_{0.45}Mn(IV)_{0.33}Al(III)_{0.05}O₂.

In accordance with a second aspect of the present invention, there is provided a method of making the cathode composition according to the first aspect, the method comprising: providing a lithium manganese aluminium oxide precursor; high-energy milling the precursor with a plurality of milling balls at a milling speed for a milling time period to form the cathode composition; wherein the precursor has oxidation states that are equal to the oxidation states of the respective elements in the cathode composition.

Contrary to known high temperature synthesis methods, the present method of making the cathode compositions does not require high temperatures. In addition, the present method provides more control over the oxidation states of the transition metals in the compositions, since the precursors can be selected according to the required oxidation states and applying the method to the precursors results in a cathode composition based on the oxidation states of the precursors without any risk of oxidation during the milling process.

The milling speed may be at least approximately 400 rpm.

The milling speed may be between approximately 400 rpm and approximately 1000 rpm.

Preferably, the milling speed is between approximately 400 rpm and approximately 700 rpm.

The milling speed may be approximately 700 rpm.

The milling time period may be between approximately 10 hours and approximately 180 hours.

The milling time period may be between approximately 40 hours and approximately 100 hours.

The milling time period may be between approximately 40 hours and approximately 80 hours.

The milling time period may be between approximately 40 hours and approximately 60 hours.

The milling time period may comprise intermittent periods of 20 minute milling and 20 minute resting.

The ratio of precursor powder to milling balls by weight may be between 1:4 and 1:20.

The lithium manganese aluminium oxide precursor may comprise a mixture of the following components:
lithium manganese (III) oxide, LiMnO₂, and/or a combination of lithium oxide Li₂O and manganese (III) oxide, Mn₂O₃.
lithium manganese (IV) oxide, Li₂MnO₃ and/or a combination of lithium oxide Li₂O and manganese (IV) oxide, MnO₂, and
aluminium oxide, Al₂O₃.

The components of the precursor may be provided in stochiometric amounts according to the final cathode composition. In particular, the components of the precursor may be provided in amounts such that the relative proportions of the different cation species in the precursor is the same as the relative proportions of the different cation species in the final cathode composition.

The lithium manganese aluminium oxide precursor may comprise lithium oxide, Li₂O, manganese (III) oxide, Mn₂O₃, manganese (IV) oxide, MnO₂, and aluminium oxide, Al₂O₃.

In this case, the components may be provided in the following molar proportions:

$$Lithium oxide , {Li}_{2} O : \frac{2}{3} - \frac{x}{6}$$

$$Manganese oxide , {Mn}_{2} {O}_{3} : \frac{x}{2} - \frac{y}{2}$$

$$Manganese oxide , {MnO}_{2} : \frac{2}{3} - \frac{2 x}{3}$$

$$Aluminium oxide , {Al}_{2} {O}_{3} : \frac{y}{2}$$

The lithium manganese aluminium oxide precursor may comprise lithium oxide, Li₂O, lithium manganese oxide, LiMnO₂, manganese (IV) oxide, MnO₂, and aluminium oxide, Al₂O₃.

In this case, the components may be provided in the following molar proportions:

$$Lithium oxide , {Li}_{2} O : \frac{2}{3} - \frac{2 x}{3} + \frac{y}{2}$$

$$Lithium manganese oxide , {LiMn}_{2} {O}_{3} : x - y$$

$$Manganese oxide , {MnO}_{2} : \frac{2}{3} - \frac{2 x}{3}$$

$$Aluminium oxide , {Al}_{2} {O}_{3} : \frac{y}{2}$$

The lithium manganese magnesium oxide precursor may comprise lithium manganese oxide, LiMnO₂, lithium manganese oxide, Li₂MnO₃, and Aluminium oxide, Al₂O₃.

In this case, the components may be provided in the following molar proportions:

$$Lithium oxide , {Li}_{2} O : \frac{y}{2}$$

$$Lithium manganese oxide , {Li}_{2} {M nO}_{3} : \frac{2}{3} - \frac{2 x}{3}$$

$$Lithium manganese oxide , {LiM nO}_{2} : x - y$$

$$Aluminium oxide , {Al}_{2} {O}_{3} : \frac{y}{2}$$

The lithium manganese magnesium oxide precursor may comprise lithium oxide, Li₂O, lithium manganese oxide, Li₂MnO₃, manganese (IV) oxide, MnO₂, and Aluminium oxide, Al₂O₃.

In this case, the components may be provided in the following molar proportions:

$$Lithium oxide , {Li}_{2} O : \frac{x}{2}$$

$$Lithium manganese oxide , {Li}_{2} {M nO}_{3} : \frac{2}{3} - \frac{2 x}{3}$$

$$Manganese oxide , {Mn}_{2} {O}_{3} : \frac{x}{2} - \frac{y}{2}$$

$$Aluminium oxide , {Al}_{2} {O}_{3} : \frac{y}{2}$$

The plurality of milling balls may comprise tungsten carbide. The high-energy milling may be performed within a ball mill jar comprising tungsten carbide.

The plurality of milling balls may comprise zirconium oxide. The high-energy milling may be performed within a ball mill jar comprising zirconium oxide.

Each of the plurality of milling balls may have a diameter of approximately 0.5 mm to approximately 1 cm.

In accordance with a third aspect of the present invention, there is provided a cathode comprising the cathode composition according to the first aspect.

In accordance with a fourth aspect of the present invention, there is provided an electrochemical cell comprising a cathode according to the third aspect, an electrolyte and an anode.

Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows X-ray diffraction patterns of the cathode compositions Li_{1.1}Mn(II)_{0.675}Mn(IV)_{0.2}Al(III)_{0.025}O₂, Li_{1.1}Mn(III)_{0.65}Mn(IV)_{0.2}Al(III)_{0.05}O₂, Li_{1.17}Mn(II)_{0.475}Mn(IV)_{0.33}Al(III)_{0.025}O₂, and Li_{1.17}Mn(III)_{0.45}Mn(IV)_{0.33}Al(II)_{0.05}O₂ in Examples 1, 2, 3 and 4, respectively;

FIG. 2 shows voltage as a function of capacity, and capacity as a function of number of cycles, for the cathode compositions Li_{1.1}Mn(II)_{0.675}Mn(IV)_{0.2}Al(III)_{0.025}O₂ (2.5% Al) and Li_{1.1}Mn(II)_{0.65}Mn(IV)_{0.2}Al(III)_{0.05}O₂(5% Al) in Examples 1 and 2, respectively; and

FIG. 3 shows voltage as a function of capacity, and capacity as a function of number of cycles, for the cathode compositions Li_{1.17}Mn(III)_{0.475}Mn(IV)_{0.33}Al(III)_{0.025}O₂ (2.5% Al) and Li_{1.17}Mn(III)_{0.45}Mn(IV)_{0.33}Al(III)_{0.05}O₂ (5% Al) in Examples 3 and 4, respectively.

### DETAILED DESCRIPTION

The present invention relates to a cathode composition for a battery of the general formula: Li₁₊ₐMn_{1-b}Al_{1-c}O₂; wherein the values of a, b and c are greater than 0.

The composition has a disordered rock salt structure, i.e. it comprises regions of rock salt having different cations, wherein the regions are disordered. In this way the rock salt effectively forms a composite rock salt material.

The inventors have determined that the cathode composition can be made using a ball milling technique. Starting materials are selected according to the desired cathode material, as will be explained in more detail below. The starting materials are then subjected to ball milling for a milling time period. The ball milling process typically takes place at room temperature, or at low temperatures such that the oxidation state of the metal cations is not altered during the process. Milling parameters can be selected as appropriate. After the ball milling process is complete, the resulting material is the disordered rock salt cathode composition.

The ball milling process advantageously allows the oxidation state of the metals to be maintained into the final cathode composition. In this way, the oxidation state, and hence the final cathode composition, can be carefully controlled.

The manganese component of the composition may comprise a plurality of oxidation states, such as Mn(III) and Mn(IV). In this case, the formula of the composition is given by:

Li₁₊ₐMn(III)_{1-b1}Mn(IV)_{1-b2}Al_{1-c}O₂

where 1−b=(1−b1)+(1−b2).

The parameters a, b and c may be inter-related. In particular, For example, the cathode composition may have the formula:

$${Li}_{\frac{4}{3} - \frac{x}{3}} {Mn ( III )}_{x - y} {Mn ( IV )}_{\frac{2}{3} - \frac{2 x}{3}} {Al ( III )}_{y} {O}_{2}$$

In this case:

$$a = \frac{1}{3} - \frac{x}{3}$$

$$b 1 = 1 + y - x$$

$$b 2 = \frac{1}{3} + \frac{2 x}{3}$$

$$c = y$$

The cathode composition may also have the formula:

$${Li}_{\frac{4}{3} - \frac{x}{3} - \frac{q}{3}} {Mn ( III )}_{x - y} {Mn ( IV )}_{\frac{2}{3} - \frac{2 x}{3} - \frac{2 q}{3}} {Al ( III )}_{y + q} {O}_{2}$$

The lithium manganese aluminium oxide precursor may comprise a mixture of powdered oxide materials. The materials include oxides of lithium, manganese 3+, manganese 4+ and aluminium, i.e. all the cation species that must be present in the final cathode material.

In particular the precursor may comprise the following components:
lithium manganese (III) oxide, LiMnO₂, and/or a combination of lithium oxide Li₂O and manganese (III) oxide, Mn₂O₃.
lithium manganese (IV) oxide, Li₂MnO₃ and/or a combination of lithium oxide Li₂O and manganese (IV) oxide, MnO₂, and
aluminium oxide, Al₂O₃.

The proportions of the starting materials are chosen to provide stochiometric amounts of the cations that correspond to the stochiometric amounts in the final material. In particular, the components of the precursor may be provided in amounts such that the relative proportions of the different cation species in the precursor is the same as the relative proportions of the different cation species in the final cathode composition.

For example, where the lithium manganese aluminium oxide precursor comprises lithium oxide, Li₂O, manganese (III) oxide, Mn₂O₃, manganese (IV) oxide, MnO₂, and aluminium oxide, Al₂O₃, the components may be provided in the following molar proportions:

$$Lithium oxide , {Li}_{2} O : \frac{2}{3} - \frac{x}{6}$$

$$Manganese oxide , {Mn}_{2} {O}_{3} : \frac{x}{2} - \frac{y}{2}$$

$$Manganese oxide , {MnO}_{2} : \frac{2}{3} - \frac{2 x}{3}$$

$$Aluminium oxide , {Al}_{2} {O}_{3} : \frac{y}{2}$$

Where the lithium manganese aluminium oxide precursor comprises lithium oxide, Li₂O, lithium manganese oxide, LiMnO₂, manganese (IV) oxide, MnO₂, and aluminium oxide, Al₂O₃, the components may be provided in the following molar proportions:

$$Lithium oxide , {Li}_{2} O : \frac{2}{3} - \frac{2 x}{3} + \frac{y}{2}$$

$$Lithium manganese oxide , {LiMnO}_{2} : x - y$$

$$Manganese oxide , {MnO}_{2} : \frac{2}{3} - \frac{2 x}{3}$$

$$Aluminium oxide , {Al}_{2} {O}_{3} : \frac{y}{2}$$

Where the lithium manganese magnesium oxide precursor may comprise lithium manganese oxide, LiMnO₂, lithium manganese oxide, Li₂MnO₃, and Aluminium oxide, Al₂O₃, the components may be provided in the following molar proportions:

$$Lithium oxide , {Li}_{2} O : \frac{y}{2}$$

$$Lithium manganese oxide , {Li}_{2} {MnO}_{3} : \frac{2}{3} - \frac{2 x}{3}$$

$$Lithium manganese oxide , {LiMnO}_{2} : x - y$$

$$Aluminium oxide , {Al}_{2} {O}_{3} : \frac{y}{2}$$

Where the lithium manganese magnesium oxide precursor comprises lithium oxide, Li₂O, lithium manganese oxide, Li₂MnO₃, manganese (IV) oxide, MnO₂, and Aluminium oxide, Al₂O₃, the components may be provided in the following molar proportions:

$$Lithium oxide , {Li}_{2} O : \frac{x}{2}$$

$$Lithium manganese oxide , {Li}_{2} {MnO}_{3} : \frac{2}{3} - \frac{2 x}{3}$$

$$Manganese oxide , {Mn}_{2} {O}_{3} : \frac{x}{2} - \frac{y}{2}$$

$$Aluminium oxide , {Al}_{2} {O}_{3} : \frac{y}{2}$$

The ball milling process parameters may be any suitable parameters. In particular:

The ball milling time period is a time that is sufficient to produce the cathode composition, which may be for example at least 10 hours.

The material of the balls and/or the container may be any suitable material such as for example tungsten carbide or zirconium oxide.

A ratio of balls to precursor may be any suitable ratio to provide sufficient milling to produce the cathode composition. For example the ratio of precursor to milling balls by weight may be between 1:4 and 1:20, though other suitable ratios may be used.

The milling speed may be any suitable milling speed that is sufficient to produce the cathode composition, which may be for example at least approximately 400 rpm.

The composition can be incorporated into a cathode in any suitable form.

Aspects of the present invention include a method of making the cathode composition for a battery, a cathode comprising the cathode composition, and an electrochemical cell comprising the cathode.

The present invention will now be illustrated with reference to the following examples.

### Example 1

Li_{1.1}Mn(III)_{0.675}Mn(IV)_{0.2}Al(III)_{0.025}O₂
a=0.1
b=0.125; b1=0.325; b2=0.8
c=0.975

A lithium manganese aluminium oxide (LiMnAlO₂) precursor was prepared. The precursor comprised 14.326 g (71.63 wt %) LiMnO₂, 0.2854 g (1.427 wt %) Al₂O₃, 5.28 g (26.4 wt %) Li₂MnO₃, and 0.084 g (0.42 wt %) Li₂O. The precursor was provided in a 20 ml ball mill jar made of tungsten carbide. 80 tungsten carbide milling balls each having a diameter of 5 mm were also provided in the ball mill jar. High-energy milling was used to mill the precursor at a milling speed of 700 rpm for a milling time period of 20 hours to form a cathode composition of the formula: Li_{1.1}Mn(II)_{0.675}Mn(IV)_{0.2}Al(III)_{0.025}O₂. The milling time period included intermittent periods of 20 minute milling and 20 minute resting, repeated 30 times. This results in formation of 20 g of Li_{1.1}Mn(II)_{0.675}Mn(IV)_{0.2}Al(III)_{0.025}O₂ powder inside the ball mill jar. The composition has a disordered rock salt crystal structure. The composition constitutes doping of 2.5% Al into Li_{1.1}Mn_{0.9}O₂. The oxidation states of the elements in the precursor are as follows:

| Element in Precursor | Oxidation State |
|---|---|
| Li in LiMnO₂ | +1 |
| Mn in LiMnO₂ | +3 |
| Al in Al₂O₃ | +3 |
| Li in Li₂MnO₃ | +1 |
| Mn in Li₂MnO₃ | +4 |
| Li in Li₂O | +1 |

The oxidation states of Li, Mn and Al in the cathode composition Li_{1.1}Mn(II)_{0.675}Mn(IV)_{0.2}Al(III)_{0.025}O₂ are equivalent to the oxidation states of the elements in the precursor as provided in the above table.

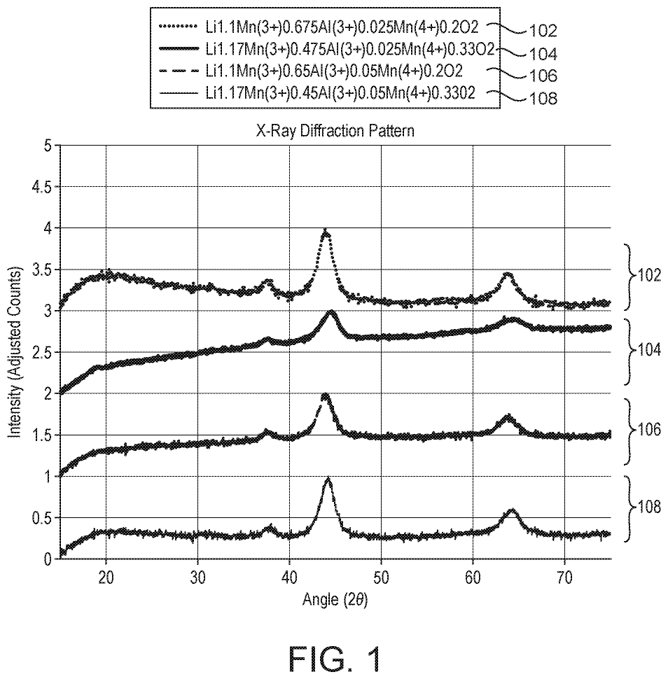

The X-ray diffraction pattern 102 of the cathode composition Li_{1.1}Mn(III)_{0.675}Mn(IV)_{0.2}Al(III)_{0.005}O₂ is shown in FIG. 1, demonstrating the crystalline structure of the composition. The XRD pattern is characteristic of a cation disordered rock salt structure. The pattern appears to show the broad major peaks consistent with a face centred cubic lattice with the Fm3(bar)m space group, as shown in FIG. 1. There is no evidence for the presence of the layered precursors such as LiMnO₂ or Li₂MnO₃.

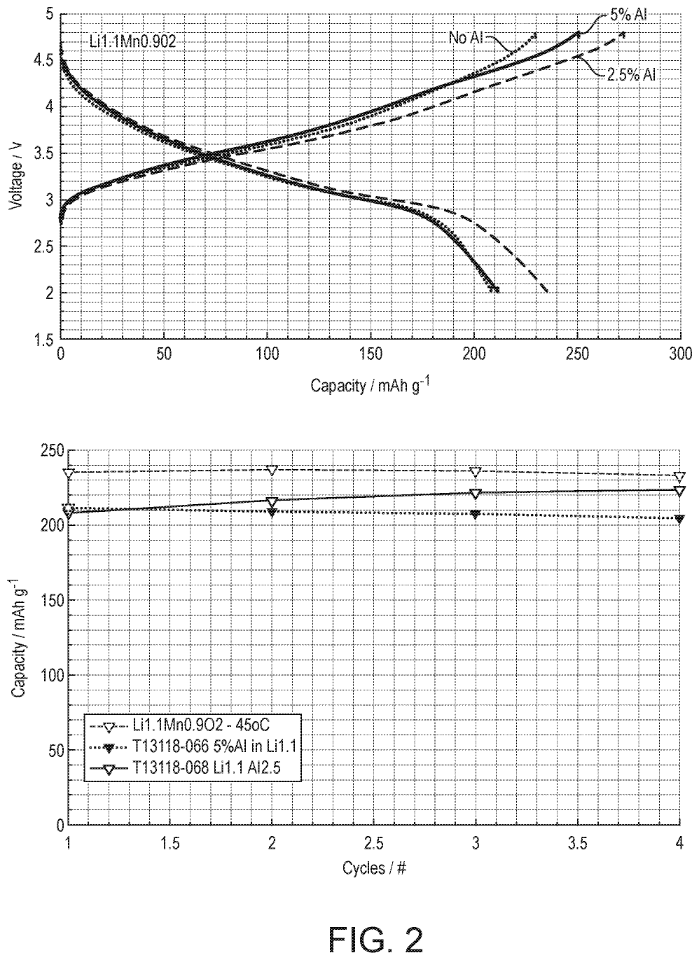

FIG. 2 shows voltage as a function of capacity, and capacity as a function of number of cycles, for the cathode composition Li_{1.1}Mn(II)_{0.675}Mn(IV)_{0.2}Al(III)_{0.025}O₂. This demonstrates that the composition can be cycled effectively.

### Example 2

Li_{1.1}Mn(II)_{0.65}Mn(IV)_{0.2}Al(II)_{0.05}O₂
a=0.1
b=0.15; b1=0.35; b2=0.8
c=0.95

A lithium manganese aluminium oxide (LiMnAlO₂) precursor was prepared. The precursor comprised 13.93 g (69.65 wt %) LiMnO₂, 0.582 g (2.91 wt %) Al₂O₃, 5.326 g (26.63 wt %) Li₂MnO₃, and 0.17 g (0.85 wt %) Li₂O was provided in a 20 ml ball mill jar made of tungsten carbide. 80 tungsten carbide milling balls each having a diameter of 5 mm were also provided in the ball mill jar. High-energy milling was used to mill the precursor at a milling speed of 700 rpm for a milling time period of 20 hours to form a cathode composition of the formula: Li_{1.1}Mn(III)_{0.65}Mn(IV)_{0.2}Al(III)_{0.05}O₂. The milling time period included intermittent periods of 20 minute milling and 20 minute resting, repeated 30 times. This results in formation of 20 g of Li_{1.1}Mn(III)_{0.65}Mn(IV)_{0.2}Al(III)_{0.05}O₂ powder inside the ball mill jar. The composition has a disordered rock salt crystal structure. The composition constitutes doping of 5% Al into Li_{1.1}Mn_{0.9}O₂. The oxidation states of the elements in the precursor are as follows:

| Element in Precursor | Oxidation State |
|---|---|
| Li in LiMnO₂ | +1 |
| Mn in LiMnO₂ | +3 |
| Al in Al₂O₃ | +3 |
| Li in Li₂MnO₃ | +1 |
| Mn in Li₂MnO₃ | +4 |
| Li in Li₂O | +1 |

The oxidation states of Li, Mn and Al in the cathode composition Li_{1.1}Mn(II)_{0.65}Mn(IV)_{0.2}Al(II)_{0.05}O₂ are equivalent to the oxidation states of the elements in the precursor as provided in the above table.

The X-ray diffraction pattern 106 of the cathode composition Li_{1.1}Mn(III)_{0.65}Mn(IV)_{0.2}Al(III)_{0.05}O₂ is shown in FIG. 1, demonstrating the crystalline structure of the composition. The XRD pattern is characteristic of a cation disordered rock salt structure. The pattern appears to show the broad major peaks consistent with a face centred cubic lattice with the Fm3(bar)m space group, as shown in FIG. 1.

There is no evidence for the presence of the layered precursors such as LiMnO₂ or Li₂MnO₃.

FIG. 2 shows voltage as a function of capacity, and capacity as a function of number of cycles, for the cathode composition Li_{1.1}Mn(II)_{0.65}Mn(IV)_{0.2}Al(III)_{0.05}O₂. This demonstrates that the composition can be cycled effectively.

### Example 3

Li_{1.17}Mn(III)_{0.475}Mn(IV)_{0.33}Al(III)_{0.025}O₂
a=0.17
b=0.195; b1=0.525; b2=0.77
c=0.975

A lithium manganese aluminium oxide (LiMnAlO₂) precursor was prepared. The precursor comprised 10.494 g (52.47 wt %) LiMnO₂, 0.296 g (1.48 wt %) Al₂O₃, 9.158 g (45.79 wt %) Li₂MnO₃, and 0.086 g (0.43 wt %) Li₂O. The precursor was provided in a 20 ml ball mill jar made of tungsten carbide. 80 tungsten carbide milling balls each having a diameter of 5 mm were also provided in the ball mill jar. High-energy milling was used to mill the precursor at a milling speed of 700 rpm for a milling time period of 20 hours to form a cathode composition of the formula: Li_{1.17}Mn(II)_{0.475}Mn(IV)_{0.33}Al(III)_{0.025}O₂. The milling time period included intermittent periods of 20 minute milling and 20 minute resting, repeated 30 times. This results in formation of 20 g of Li_{1.17}Mn(III)_{0.475}Mn(IV)_{0.33}Al(IIO)_{0.025}O₂ powder inside the ball mill jar. The composition has a disordered rock salt crystal structure. The composition constitutes doping of 2.5% Al into Li_{1.17}Mn_{0.83}O₂. The oxidation states of the elements in the precursor are as follows:

| Element in Precursor | Oxidation State |
|---|---|
| Li in LiMnO₂ | +1 |
| Mn in LiMnO₂ | +3 |
| Al in Al₂O₃ | +3 |
| Li in Li₂MnO₃ | +1 |
| Mn in Li₂MnO₃ | +4 |
| Li in Li₂O | +1 |

The oxidation states of Li, Mn and Al in the cathode composition Li_{1.17}Mn(III)_{0.475}Mn(IV)_{0.33}Al(III)_{0.025}O₂ are equivalent to the oxidation states of the elements in the precursor as provided in the above table.

The X-ray diffraction pattern 104 of the cathode composition Li_{1.17}Mn(III)_{0.475}Mn(IV)_{0.33}Al(III)_{0.025}O₂ is shown in FIG. 1, demonstrating the crystalline structure of the composition. The XRD pattern is characteristic of a cation disordered rock salt structure. The pattern appears to show the broad major peaks consistent with a face centred cubic lattice with the Fm3(bar)m space group, as shown in FIG. 1. There is no evidence for the presence of the layered precursors such as LiMnO₂ or Li₂MnO₃.

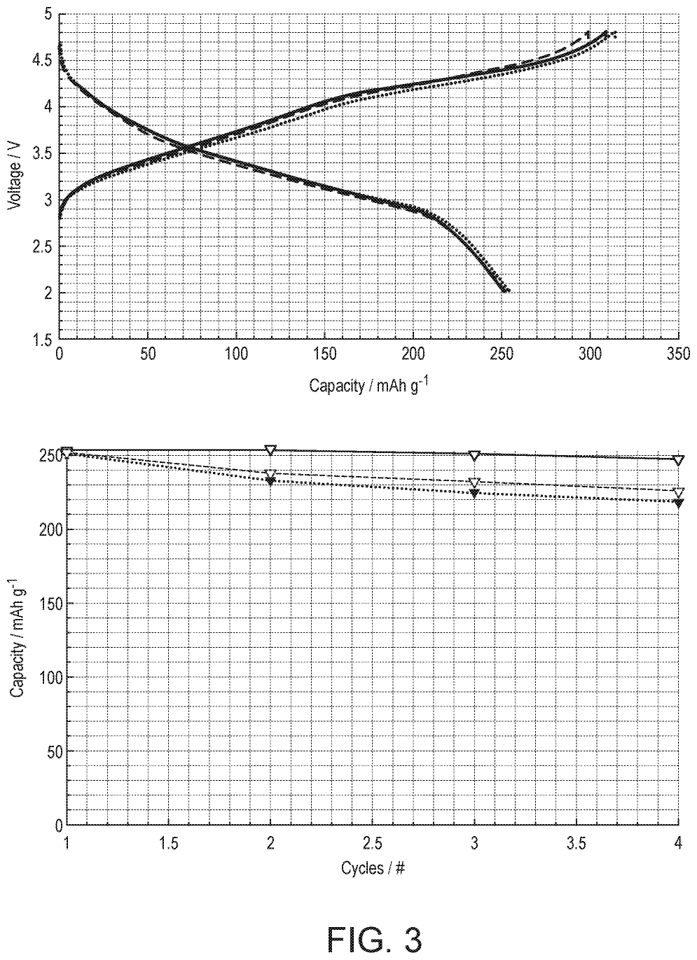

FIG. 3 shows voltage as a function of capacity, and capacity as a function of number of cycles, for the cathode composition Li_{1.17}Mn(III)_{0.475}Mn(IV)_{0.33}Al((II)_{0.025}. This demonstrates that the composition can be cycled effectively.

### Example 4

Li_{1.17}Mn(II)_{0.45}Mn(IV)_{0.33}Al(III)_{0.05}O₂
a=0.17
b=0.195; b1=0.525; b2=0.77
c=0.95

A lithium manganese aluminium oxide (LiMnAlO₂) precursor was prepared. The precursor comprised 10.026 g (50.13 wt %) LiMnO₂, 0.602 g (3.01 wt %) Al₂O₃, 9.236 g (46.18 wt %) Li₂MnO₃, and 0.176 g (0.88 wt %) Li₂O. The precursor was provided in a 20 ml ball mill jar made of tungsten carbide. 80 tungsten carbide milling balls each having a diameter of 5 mm were also provided in the ball mill jar. High-energy milling was used to mill the precursor at a milling speed of 700 rpm for a milling time period of 20 hours to form a cathode composition of the formula: Li_{1.17}Mn(II)_{0.45}Mn(IV)_{0.33}Al(III)_{0.05}O₂. The milling time period included intermittent periods of 20 minute milling and 20 minute resting, repeated 30 times. This results in formation of 20 g of Li_{1.17}Mn(II)_{0.45}Mn(IV)_{0.33}Al(III)_{0.05}O₂ powder inside the ball mill jar. The composition has a disordered rock salt crystal structure. The composition constitutes doping of 5% Al into Li_{1.17}Mn_{0.83}O₂. The oxidation states of the elements in the precursor are as follows:

| Element in Precursor | Oxidation State |
|---|---|
| Li in LiMnO₂ | +1 |
| Mn in LiMnO₂ | +3 |
| Al in Al₂O₃ | +3 |
| Li in Li₂MnO₃ | +1 |
| Mn in Li₂MnO₃ | +4 |
| Li in Li₂O | +1 |

The oxidation states of Li, Mn and Al in the cathode composition Li_{1.17}Mn(III)_{0.45}Mn(IV)_{0.33}Al(III)_{0.05}O₂ are equivalent to the oxidation states of the elements in the precursor as provided in the above table.

The X-ray diffraction pattern 108 of the cathode composition Li_{1.17}Mn(III)_{0.45}Mn(IV)_{0.33}Al(II)_{0.05}O₂ is shown in FIG. 1, demonstrating the crystalline structure of the composition. The XRD pattern is characteristic of a cation disordered rock salt structure. The pattern appears to show the broad major peaks consistent with a face centred cubic lattice with the Fm3(bar)m space group, as shown in FIG. 1.

There is no evidence for the presence of the layered precursors such as LiMnO₂ or Li₂MnO₃.

FIG. 3 shows voltage as a function of capacity, and capacity as a function of number of cycles, for the cathode composition Li_{1.17}Mn(III)_{0.45}Mn(IV)_{0.33}Al(III)_{0.05}O₂. This demonstrates that the composition can be cycled effectively.

Many modifications may be made to the specific embodiments described above without departing from the scope of the invention as defined in the accompanying claims. Features of one embodiment may also be used in other embodiments, either as an addition to such embodiment or as a replacement thereof.

The invention claimed is:

1. A cathode composition for a battery of the general formula:
Li₁₊ₐMn_{1-b}Al_{1-c}O₂
wherein the values of a, b and c are greater than 0.

2. The cathode composition according to claim 1, wherein the composition has a form of a single phase having a rock salt crystal structure such that an x-ray diffraction pattern of the composition using a Cu Ka radiation source has an absence of peaks below a 26 value of 35.

3. The cathode composition according to claim 1, wherein the manganese component of the composition comprises a plurality of different oxidation states.

4. The cathode composition according to claim 3, wherein the manganese component of the composition comprises Mn(III) and Mn(IV), and the composition has the general formula:
Li₁₊ₐMn(III)_{1-b1}Mn(IV)_{1-b2}Al_{1-c}O₂
where 1−b=(1−b1)+(1−b2).

5. The cathode composition according to claim 4, wherein the cathode composition has the formula:
$${Li}_{\frac{4}{3} - \frac{x}{3} - \frac{q}{3}} {Mn ( III )}_{x - y} {Mn ( IV )}_{\frac{2}{3} - \frac{2 x}{3} - \frac{2 q}{3}} {Al ( III )}_{y + q} {O}_{2}$$

6. The cathode composition according to claim 5, wherein the value of x is greater than approximately 0.05 and less than approximately 0.95.

7. The cathode composition according to claim 5, wherein the value of x is greater than approximately 0.45 and less than approximately 0.75.

8. The cathode composition according to claim 5, wherein the value of y+q is less than approximately 0.3.

9. The cathode composition according to claim 5, wherein the value of y+q is less than approximately 0.2.

10. The cathode composition according to claim 5, wherein the composition is Li_{1.1}Mn(III)_{0.675}Mn(IV)_{0.2}Al(III)_{0.025}O₂.

11. The cathode composition according to claim 5, wherein the composition is Li_{1.1}Mn(III)_{0.65}Mn(IV)_{0.2}Al(III)_{0.05}O₂.

12. The cathode composition according to claim 5, wherein the composition is Li_{1.17}Mn(III)_{0.475}Mn(IV)_{0.33}Al(III)_{0.025}O₂.

13. The cathode composition according to claim 5, wherein the composition is Li_{1.17}Mn(III)_{0.45}Mn(IV)_{0.33}Al(III)_{0.05}O₂.

14. A method of making the cathode composition of claim 1, the method comprising:
providing a lithium manganese aluminium oxide precursor;
high-energy milling the lithium manganese aluminium oxide precursor with a plurality of milling balls at a milling speed for a milling time period to form the cathode composition;
wherein the lithium manganese aluminium oxide precursor has oxidation states that are equal to the oxidation states of the respective elements in the cathode composition.

15. The method according to claim 14, wherein the milling speed is at least approximately 400 rpm.

16. The method according to claim 14, wherein the milling speed is between approximately 400 rpm and approximately 1000 rpm.

17. The method according to claim 14, wherein the milling speed is approximately 700 rpm.

18. The method according to claim 14, wherein the milling time period is between approximately 10 hours and approximately 180 hours.

19. The method according to claim 14, wherein the milling time period is between approximately 40 hours and approximately 100 hours.

20. The method according to claim 14, wherein the milling time period is between approximately 40 hours and approximately 80 hours.

21. The method according to claim 14, wherein the milling time period is between approximately 40 hours and approximately 60 hours.

22. The method according to claim 14, wherein the ratio of precursor powder to milling balls by weight is between 1:4 and 1:20.

23. The method according to claim 14, wherein the lithium manganese aluminium oxide precursor comprises a mixture of the following components:
lithium oxide, Li₂O,
lithium manganese (III) oxide, LiMnO₂, and/or a combination of lithium oxide Li₂O and manganese (III) oxide, Mn₂O₃,
lithium manganese (IV) oxide, Li₂MnO₃ and/or a combination of lithium oxide Li₂O and manganese (IV) oxide, MnO₂, and
aluminium oxide, Al₂O₃.

24. A cathode comprising the cathode composition according to claim 1.

25. An electrochemical cell comprising a cathode according to claim 24, an electrolyte and an anode.
